(19) United States
(12) Patent Application Publication
(10) Pub. No.: US 2018/0203710 A1
(43) Pub. Date: Jul. 19, 2018

(54) MICROCONTROLLER UNIT FOR MANAGING DATA FROM AT LEAST ONE SENSOR

(71) Applicant: SCHAEFFLER TECHNOLOGIES AG & CO. KG, Herzogenaurach (DE)

(72) Inventor: Gerald KUESTLER, Gaggenau (DE)

(73) Assignee: SCHAEFFLER TECHNOLOGIES AG & CO. KG, Herzogenaurach (DE)

(21) Appl. No.: 15/744,123

(22) PCT Filed: Jul. 21, 2016
(86) PCT No.: PCT/DE2016/200330

§ 371 Date: Jan. 12, 2018

(30) Foreign Application Priority Data
Jul. 30, 2015 (DE) 10 2015 214 449.6

(51) Int. Cl. G06F 9/445; G06F 13/10; G06F 13/40; H04L 29/08

(52) U.S. Cl. CPC G06F 9/44505; H04L 67/34; G06F 13/4068; G06F 13/102

(57) ABSTRACT

A microcontroller in a microcontroller unit, comprising a memory area including a configuration file and configured to serve as a removable data storage medium, wherein the microcontroller is connected to an interface for reading data in and out from at least one sensor, wherein the microcontroller is further configured to disconnect and restart an operating voltage of the microcontroller unit upon completion of amendments to the configuration file.

### CROSS-REFERENCE TO RELATED APPLICATIONS

This application is the U.S. National Phase of PCT/DE2016/200330 filed Jul. 21, 2016, which claims priority to DE 102015214449.6 filed Jul. 30, 2015, the entire disclosures of which are incorporated by reference herein.

### TECHNICAL FIELD

The disclosure relates to a microcontroller unit for managing data from at least one sensor, including at least one sensor interface and a supply-voltage connector, said at least one sensor interface and said supply-voltage connector being connected to a microcontroller.

### BACKGROUND

Microcontroller units that exhibit a microcontroller and that process and integrate data from various sensors are designated as sensor hubs. When such a sensor hub is to be configured, separate software is necessary which has to be installed and executed on a measuring computer. At the same time, CAN dbc files are generated with this separate software. These dbc files have to be held on the respective measuring computer. Without major effort, firmware updates can only be undertaken at the factory, and they cannot be amended on the customer's premises.

The object underlying the disclosure is to specify a microcontroller unit that can be configured easily and inexpensively for the purpose of managing data from at least one sensor.

In accordance with the disclosure, a microcontroller exhibits a demarcated memory area, serving as removable data storage medium, which is connected to an interface for reading data in and/or out, wherein at least one configuration file and/or a dbc file and/or microcontroller software and/or an operating manual has been stored in the memory area. At the external PC to be linked to the microcontroller unit, this memory area appears as a removable data storage medium, so that in this predetermined memory area arbitrary data and software programs can be adapted by use of the PC, in which case said data and software programs can be assigned to the sensor to be linked in the given case. These amendments can be undertaken directly on the customer's premises, in which case adaptive programming on the premises of the manufacturer of the microcontroller unit becomes unnecessary. The dbc file (dbc=data base CAN file format for exchanging CAN bus data) and the measuring device, in the form of the sensor and the microcontroller unit, may be locally together, and the searching or generating of a dbc file in the event of the sensor and the microcontroller unit being passed on may become unnecessary. The operating manual that has been stored as a PDF file may also be accessible and locally connected to the microcontroller unit. After the microcontroller unit has been linked to the external computing unit, the operating manual can be accessed at any time without having to look up anything on the Internet or on an installation CD.

### SUMMARY

Advantageously, the interface for reading data in and/or out takes the form of a USB interface. Since all external devices nowadays are equipped with USB interfaces, a simple connection of the microcontroller unit to the external data storage media or computing units is possible, by using the memory area serving as removable data storage medium can then be accessed easily and the desired amendments can be undertaken.

In one configuration, a CAN transceiver unit is arranged between the microcontroller and a CAN interface. By virtue of this configuration, the microcontroller unit can also be easily linked to a CAN bus of a vehicle, where it can participate in the transmission of data within a vehicle.

In one variant, the configuration file that has been saved in the memory area serving as removable data storage medium serves for adaptation to a type of sensor. This configuration file has advantageously been stored as a text file. After the microcontroller unit has been linked to an external computing unit via the USB interface, said external computing unit can be easily opened by the user and adapted there to, for example, data-transmission conditions such as a sampling-frequency or a CAN identification number. Separate software to be made available on the external computing unit becomes unnecessary.

In one practical form, the dbc file can be modified by use of a text editor. This enables particularly easy accessibility of the dbc file, the amended dbc file always being passed on with the microcontroller unit.

In one configuration, microcontroller software has been saved in compiled form in the memory area serving as removable data storage medium. Since the software is present in a form that can be read at any time by an external computer, a user is able to write a new software file to the predetermined memory area independently.

A further development of the disclosure relates to a method for amending configuration of a microcontroller unit that manages data from at least one sensor. In the case of a method in which the data supplied by sensors can be edited and managed as easily as possible, for the purpose of amending data in a file that has been stored in a demarcated memory area, taking the form of a removable data storage medium, of a microcontroller of the microcontroller unit, the memory area is accessed via a USB port and the file is opened, whereby after completion of the amendments the data are stored and the file is closed and, for the purpose of activating the amendments, an operating voltage of the microcontroller unit is disconnected and restarted. As a result of such a simple reboot of the microcontroller unit, the software can advantageously be activated in the microcontroller unit. A complicated flash process with separate tools becomes unnecessary.

Advantageously, after the operating voltage has been disconnected a predetermined time is waited out until the operating voltage is again applied to the microcontroller unit. As a result, the microcontroller unit is given the information that it is not a question of an accidental disconnection, but rather an update of the amended software is desired.

### BRIEF DESCRIPTION OF THE DRAWINGS

The disclosure permits numerous practical forms. One of them will be elucidated in more detail with reference to the FIGURES represented in the drawing, in which:

FIG. 1 shows an embodiment of the microcontroller unit according to the disclosure.

### DETAILED DESCRIPTION

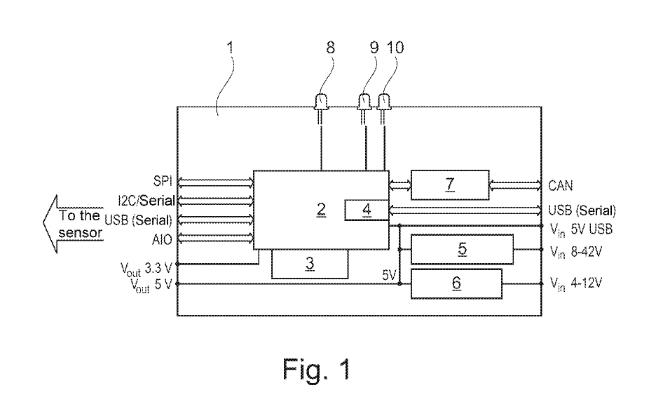

An embodiment of the microcontroller unit 1 according to the disclosure is represented in FIG. 1. This microcontroller unit 1 includes a microcontroller 2 which exhibits a module 3 for wireless data transmission. Within the microcontroller 2 a demarcated memory area 4 is provided, in which selected files can be stored and amended by customers. The microcontroller 2 exhibits several input interfaces to which at least one sensor, not represented in any detail, can be linked. The first interface is a Serial Peripheral Interface (SPI interface), the second interface takes the form of an Inter-Integrated Circuit (I²C) interface, whereas a Universal Serial Bus (USB) interface constitutes the third interface. In addition, an analog input/output interface is present. Furthermore, the microcontroller 2 provides for the sensor a voltage of 3.3 volts at a first input interface and a voltage of 5 volts at a second output interface.

The microcontroller unit 1 exhibits a first converter 5 which is connected to a first input interface Vⁱⁿ 8-42 V at which an operating voltage between 8 V and 42 V can be made available, and which can be modified in converter 5 in 5-volt steps. At a second input interface Vⁱⁿ 4-12 V an operating voltage of 4 volts to 12 volts can be applied which can be modified by a second converter 6, arranged within the microcontroller unit 1, in steps of 5 volts and applied to the microcontroller 2.

The demarcated memory area 4 of the microcontroller 2 is connected to a USB interface USB (Serial) of the microcontroller unit 1, to which a USB port of an external computing unit can be linked. In this way, a user can access the files stored in the predetermined memory area 4 and amend them at will. These files situated in the demarcated memory area 4 include, for instance, a configuration file in the form of a text file, a dbc file, an operating manual in pdf form, and the software of the microcontroller unit 1 in compiled form. To the user of the microcontroller unit 1 the predetermined demarcated memory area 4 appears as a removable data storage medium with which he/she can deliberately undertake amendments in the configuration of the microcontroller unit 1.

In addition, the microcontroller unit 1 is connected via a CAN transceiver unit 7 to a CAN interface CAN which, particularly in the case of application in a motor vehicle, can be linked to the CAN of the vehicle and enables an appropriate exchange of data there. Moreover, the microcontroller unit 1 exhibits status LEDs 8, 9, 10 which are arranged on the outside of the microcontroller unit 1.

If a new sensor is linked to the microcontroller unit 1, the microcontroller 2 of the microcontroller unit 1 can be adapted to this sensor. In the following, a configuration of an acceleration sensor for measuring longitudinal accelerations of a vehicle will be considered. For this purpose, an external computing unit is linked to the USB port USB (Serial) of the microcontroller unit 1, and in the demarcated memory area 4 of the microcontroller 3 the configuration file is called up.

The acceleration sensor exhibits three sensor axes, the values of which lie between −1 and 1. In a first step, a sensor-axis offset for each sensor axis is defined in g, the offset being set to 0 for the X, Y and Z axes. It will be assumed that the deviation of the offset may amount to at most +/−0.3 g.

Furthermore, the CAN identification number is entered in hexadecimal numbers, for instance CAN-ID=7FD.

The sampling-frequency of the sensor signals, which may lie between 1, 10, 100 and 1000 hertz, is set to 1000 hertz in the present case.

The CAN-bus transmission frequency is set to 1 million bits per second.

In addition, a gravitational acceleration of 9.80665 m/s² is entered.

After this configuration has been undertaken in the configuration file of the microcontroller 2, this configuration file is stored and closed. Subsequently the operating voltage is disconnected. After this, the operating voltage is again applied to the microcontroller unit 1, whereby upon application of the operating voltage a self-test of the data is carried out. The serial baud rate, which may amount to between 9600, 19,200, 57,600, 115,200, 230,400, 460,800 and 921,600, is set to 921,600.

In the course of the configuration of the acceleration sensor, advantageous settings can additionally be chosen. Accordingly, the cut-off frequency of a digital low-pass filter for the acceleration signal can be selected between the following values:

0=1130 hertz, 1=460 hertz, 2=184 hertz, 3=92 hertz, 4=41 hertz, 5=20 hertz, 6=10 hertz, 7=5 hertz.

The cut-off frequency for the digital low-pass filter for gyro signals may amount to between

0=3600 hertz, 1=250 hertz, 2=184 hertz, 3=62 hertz, 4=41 hertz, 5=20 hertz, 6=10 hertz, 7=5 hertz.

The described solution permits a simple configuration of the microcontroller unit 1 via the external computing unit linked to the USB interface. Since the sensor is always passed on with the microcontroller unit 1, a local encounter may be guaranteed at any time and the data stored in the microcontroller unit 1 are permanently assigned to the selected sensor.

### LIST OF REFERENCE SYMBOLS

1 microcontroller unit
2 microcontroller
3 module for wireless data transmission
4 memory area
5 converter
6 converter
7 CAN transceiver unit
8 LED
9 LED
10 LED

1. A microcontroller unit for managing data from at least one sensor, comprising:
at least one sensor interface and a supply-voltage connector, wherein the at least one sensor interface and the supply-voltage connector is connected to a microcontroller, wherein the microcontroller includes a demarcated memory area, serving as removable data storage medium, which is connected to an interface for reading data in and out, wherein at least one configuration file, a database CAN (dbc) file, microcontroller software, or an operating manual has been stored in the memory area.

2. The microcontroller unit of claim 1, wherein the interface for reading data in and out is a USB interface.

3. The microcontroller unit of claim 1, wherein a CAN transceiver unit is arranged between the microcontroller and a CAN interface.

4. The microcontroller unit of claim 1, wherein the configuration file saved in the memory area serving as removable data storage medium serves for adaptation to a type of sensor.

5. The microcontroller unit of claim 1, wherein the dbc file can be modified by a text editor.

6. The microcontroller unit of claim 1, wherein the microcontroller software stored in the memory area serving as removable data storage medium has been saved in compiled form.

7. A method for amending a configuration of a microcontroller unit that manages data from at least one sensor, comprising:
amending data in a file that has been stored in a demarcated memory area of a microcontroller of a microcontroller unit;
accessing via an interface the demarcated memory area;
opening the file upon completion of amendments of the data;
storing the date after the file is closed; and
in response to activating the amendments, disconnect and restart an operating voltage of the microcontroller unit.

8. The method of claim 7, wherein a predetermined time is waited out before the operating voltage is again applied to the microcontroller unit.

9. A microcontroller in a microcontroller unit, comprising:
a memory area including a configuration file and configured to serve as a removable data storage medium, wherein the microcontroller is connected to an interface for reading data in and out from at least one sensor, wherein the microcontroller is further configured to disconnect and restart an operating voltage of the microcontroller unit upon completion of amendments to the configuration file.

10. The microcontroller of claim 9, wherein the configuration file includes one or more of a database CAN (dbc) file, microcontroller software, or an operating manual.

11. The microcontroller of claim 9, wherein a CAN transceiver unit is arranged between the microcontroller and a CAN interface.

12. The microcontroller of claim 9, wherein the sensor is an acceleration sensor for measuring longitudinal accelerations of a vehicle.

13. The microcontroller of claim 9, wherein the microcontroller is configured to store and close the configuration file upon an undertaking of the configuration file and an operating voltage is disconnected.

14. The microcontroller of claim 9, wherein the memory area is configured to appear as a removable data storage medium at an external PC linked to the microcontroller.

15. The microcontroller of claim 9, wherein the configuration file includes a CAN identification number.

16. The microcontroller of claim 9, wherein the configuration file serves for adaptation the at least one sensor.

17. The microcontroller of claim 9, wherein the configuration file can be modified by using a text editor.
